(19) United States
(12) Patent Application Publication
(10) Pub. No.: US 2026/0063289 A1
(43) Pub. Date: Mar. 5, 2026

(54) Light conversion component for mounting on a heat exchanger

(71) Applicant: SCHOTT AG, Mainz (DE)

(72) Inventor: Albrecht SEIDL, Mainz (DE)

(21) Appl. No.: 19/318,872

(22) Filed: Sep. 4, 2025

(30) Foreign Application Priority Data
Sep. 5, 2024 (DE) 102024125458.0

(51) Int. Cl. F21V 29/502; F21V 9/30

(52) U.S. Cl. CPC F21V 29/502; F21V 9/30

(57) ABSTRACT

A light conversion component for mounting on a heat exchanger including: a light conversion element having a front side and a rear side, wherein the light conversion element is configured to be irradiated with primary light on its front side and to emit secondary light with a wavelength changed relative to the primary light on its front side, and a thermally conductive carrier substrate, which carries the light conversion element, wherein the carrier substrate has a carrier front side facing the rear side of the light conversion element, and has a carrier rear side configured for bearing on the heat exchanger, and a thermally conductive connector, which is arranged between the light conversion element and the carrier substrate and which establishes a mechanically fixed connection.

This claims priority to German patent application 10 2024 125 458.0, filed on Sep. 5, 2024 which is hereby incorporated by reference herein.

The invention relates to a light conversion component for mounting on a heat exchanger.

### BACKGROUND

Light conversion components are used in various applications, for example in the field of projection or as white light sources, wherein sometimes in the context thereof a very high luminous flux can be present.

A light conversion component constitutes a converter-heat spreader composite assembly, wherein the actual light conversion takes place in a light conversion element, which provides the light-converting properties and is embodied e.g. as a converter platelet. In order to be able to effectively dissipate the heat generated in the light conversion element owing to incomplete conversion, the light conversion element is attached on a thermally conductive carrier substrate by means of a thermally conductive connector, wherein the carrier substrate can also be referred to as a heat spreader. Designs of light conversion components in which a fixed attachment of the light conversion element is provided are also known as static designs.

### SUMMARY OF THE INVENTION

In the application, the light conversion component is typically mounted on a heat exchanger, which can also be referred to as a heat sink, wherein a releasable connection is generally preferred in this case.

It is an object of the present invention to provide light conversion components for mounting on a heat exchanger, wherein the heat dissipation and/or the luminous efficiency is optimized. According to one aspect of the object of the invention, it is sometimes also desirable to enable the smallest possible designs, since the available space in a light source is sometimes very limited, for example in so-called picoprojectors. According to a further aspect of the object of the invention, it is sometimes desirable to minimize the costs of the thermally conductive carrier substrate.

The present invention provides a light conversion component for mounting on a heat exchanger, in particular for manually exchangeable mounting on a heat exchanger by means of a heat conducting medium, e.g. a heat conducting paste or a heat conducting pad. Such a heat exchanger on which the light conversion component according to the invention is mountable can also be referred to as a heat sink.

The light conversion component comprises, firstly, a light conversion element having a front side and a rear side, wherein the light conversion element is configured to be irradiated with primary light on its front side and to emit secondary light with a wavelength changed relative to the primary light on its front side. The light conversion element has light-converting properties and can also be referred to in simplified terms as a converter.

The light conversion component furthermore comprises a thermally conductive carrier substrate, which carries the light conversion element, wherein the carrier substrate has a carrier front side facing the rear side of the light conversion element and has a carrier rear side configured for bearing on a heat exchanger. The thermally conductive carrier substrate can also be referred to as a heat spreader.

The light conversion component furthermore comprises a thermally conductive connector, which is arranged between the light conversion element and the carrier substrate, and which establishes a mechanically fixed connection.

With regard to the dimensions of the carrier substrate, it is preferably provided that the carrier substrate defines a characteristic area CA, which is given as the surface area of the carrier rear side, in particular as the surface area of the contact region between the carrier rear side and the heat exchanger, when the carrier substrate is mounted on the heat exchanger.

The characteristic area CA thus in principle corresponds in particular to the surface area of the carrier rear side. The characteristic area CA can also correspond to the surface area of the contact region, i.e. in particular the projection of the in contact part of the carrier rear side onto a plane, e.g. if the carrier rear side is not flat, for example is grooved, or is only regionally in contact with the heat exchanger.

Preferably, it is furthermore provided that the carrier substrate defines a characteristic length CL=2·(CA/π)^{0.5}, which is given as the diameter of a circular surface having a surface area corresponding to the characteristic area CA.

According to one preferred embodiment of the invention, it is provided that the characteristic length CL of the carrier substrate is preferably greater than 1 mm and is preferably less than 23 mm.

With regard to the dimensions of the carrier substrate, it is furthermore preferably provided that the carrier substrate defines a characteristic height CH, which is given as the thickness of the carrier substrate, in particular at the position at which the carrier substrate carries the light conversion element, in particular as the distance between the position of the geometric centroid of the light conversion element on the carrier front side and the plane defined by the carrier rear side. In other words, the distance corresponds to the perpendicular from the geometric centroid of the light conversion element on the carrier front side to the plane of the carrier rear side.

The characteristic height CH thus in principle corresponds in particular to the thickness of the carrier substrate. The characteristic height CH can also correspond to the thickness of the carrier substrate at that point at which the converter is arranged, especially if the thickness of the carrier substrate is not uniform. The characteristic height CH can also correspond to the distance between the abovementioned geometric centroids, especially if the thickness of the converter is not uniform.

According to one preferred embodiment of the invention, it is provided that the characteristic height CH of the carrier substrate is preferably greater than 0.2 mm and is preferably less than 4 mm.

With regard to the heat conduction of the carrier substrate, it is preferably provided that the carrier substrate defines a characteristic thermal resistance CHR=CH/λ/CA, which is given as the quotient of the characteristic height CH of the carrier substrate and the thermal conductivity λ of the carrier substrate and the characteristic area CA of the carrier substrate.

According to one preferred embodiment of the invention, it can be provided that the characteristic thermal resistance CHR of the carrier substrate is in a range of 0.0001 K/W to 0.07 K/W.

In particular, in this aforementioned embodiment, the characteristic length CL of the carrier substrate can preferably be in a range of 23 mm to 100 mm.

In particular, in this aforementioned embodiment, the characteristic height CH of the carrier substrate can preferably be in a range of 0.2 mm to 12 mm.

In other words, it can be provided in particular that if the characteristic length CL is in a range of 23 mm to 100 mm and optionally furthermore the characteristic height CH of the carrier substrate is in a range of 0.2 mm to 12 mm, the characteristic thermal resistance CHR of the carrier substrate is in a range of 0.0001 K/W to 0.07 K/W.

According to one preferred embodiment of the invention, it can be provided that the characteristic thermal resistance CHR of the carrier substrate is in a range of 0.001 K/W to 0.2 K/W, preferably is in a range of 0.003 K/W to 0.08 K/W, particularly preferably is in a range of 0.005 K/W to 0.03 K/W.

In particular, in this aforementioned embodiment, the characteristic length CL of the carrier substrate can preferably be in a range of 13 mm to 23 mm.

In particular, in this aforementioned embodiment, the characteristic height CH of the carrier substrate can preferably be in a range of 0.2 mm to 12 mm, particularly preferably be in a range of 0.5 mm to 12 mm, even more preferably be in a range of 0.8 mm to 4 mm.

In other words, it can be provided in particular that if the characteristic length CL is in a range of 13 mm to 23 mm and optionally furthermore the characteristic height CH of the carrier substrate is in a range of 0.2 mm to 12 mm, particularly preferably is in a range of 0.5 mm to 12 mm, even more preferably is in a range of 0.8 mm to 4 mm, the characteristic thermal resistance CHR of the carrier substrate is in a range of 0.001 K/W to 0.2 K/W, preferably is in a range of 0.003 K/W to 0.08 K/W, particularly preferably is in a range of 0.005 K/W to 0.03 K/W.

According to one preferred embodiment of the invention, it can be provided that the characteristic thermal resistance CHR of the carrier substrate is in a range of 0.005 K/W to 0.23 K/W, preferably is in a range of 0.013 K/W to 0.13 K/W, particularly preferably is in a range of 0.021 K/W to 0.05 K/W.

In particular, in this aforementioned embodiment, the characteristic length CL of the carrier substrate can preferably be in a range of 9 mm to 13 mm.

In particular, in this aforementioned embodiment, the characteristic height CH of the carrier substrate can preferably be in a range of 0.2 mm to 9 mm, particularly preferably be in a range of 0.5 mm to 5 mm, even more preferably be in a range of 0.8 mm to 2 mm.

In other words, it can be provided in particular that if the characteristic length CL is in a range of 9 mm to 13 mm and optionally furthermore the characteristic height CH of the carrier substrate is in a range of 0.2 mm to 9 mm, particularly preferably is in a range of 0.5 mm to 5 mm, even more preferably is in a range of 0.8 mm to 2 mm, the characteristic thermal resistance CHR of the carrier substrate is in a range of 0.005 K/W to 0.23 K/W, preferably is in a range of 0.013 K/W to 0.13 K/W, particularly preferably is in a range of 0.021 K/W to 0.05 K/W.

According to one preferred embodiment of the invention, it can be provided that the characteristic thermal resistance CHR of the carrier substrate is in a range of 0.01 K/W to 10 K/W, preferably is in a range of 0.01 K/W to 0.21 K/W, preferably is in a range of 0.026 K/W to 0.1 K/W, particularly preferably is in a range of 0.042 K/W to 0.06 K/W.

In particular, in this aforementioned embodiment, the characteristic length CL of the carrier substrate can preferably be in a range of 1 mm to 9 mm.

In particular, in this aforementioned embodiment, the characteristic height CH of the carrier substrate can preferably be in a range of 0.2 mm to 4 mm, particularly preferably be in a range of 0.5 mm to 2 mm, even more preferably be in a range of 0.8 mm to 1.2 mm.

In other words, it can be provided in particular that if the characteristic length CL is in a range of 1 mm to 9 mm and optionally furthermore the characteristic height CH of the carrier substrate is in a range of 0.2 mm to 4 mm, particularly preferably is in a range of 0.5 mm to 2 mm, even more preferably is in a range of 0.8 mm to 1.2 mm, the characteristic thermal resistance CHR of the carrier substrate is in a range of 0.01 K/W to 10 K/W, preferably is in a range of 0.01 K/W to 0.21 K/W, preferably is in a range of 0.026 K/W to 0.1 K/W, particularly preferably is in a range of 0.042 K/W to 0.06 K/W.

The light conversion element is mounted in particular on the carrier front side as described. However, the carrier substrate can have indeed larger dimensions than the light conversion element, e.g. in order to enable the fixing of the carrier substrate on a heat exchanger in a simple manner.

In particular, it can be provided that the carrier substrate, in particular the carrier front side, has a coverage area covered by the light conversion element, and has a free area not covered by the light conversion element.

The free area can have an area which is preferably in a range of 1 mm² to 400 mm², particularly preferably is in a range of 10 mm² to 130 mm², even more preferably is in a range of 20 mm² to 60 mm².

The ratio of the area of the coverage area to the area of the free area can preferably be in a range of 0.01 to 2.5, particularly preferably be in a range of 0.1 to 1, even more preferably be in a range of 0.2 to 0.5.

The carrier substrate can preferably have a mounting region located in the free area of the carrier substrate, wherein the mounting region preferably forms or comprises a mounting structure, by means of which the carrier substrate is securable, e.g. is clampable or is screwable, on the heat exchanger, wherein the mounting structure is formed e.g. as an edge region of the carrier substrate not covered by the light conversion element, or is formed as a recess, open on the edge side in particular, in the carrier substrate.

The carrier substrate preferably has a shape which is suitable for being produced by stamping.

The carrier substrate can be disc-shaped, plate-shaped or cylindrical, in particular with a round, oval, angular or rectangular boundary.

The carrier substrate can be shaped so as to be “simply connected” in the mathematical-topological sense, in particular in such a way that the carrier substrate has no through holes.

The carrier substrate can have an outwardly oriented edge connecting the carrier front side to the carrier rear side, wherein the carrier substrate preferably has only the outwardly oriented edge, in particular has no inwardly oriented edge.

The carrier substrate can have a uniform thickness or a minimum thickness which deviates from the maximum thickness by at most 50%, or deviates by at most 10%, in particular in such a way that the carrier substrate does not comprise any steps or horizontal areas located between the carrier front side and the carrier rear side.

The carrier substrate can be produced by stamping, in particular can be produced as a stamped disc or stamped platelet. This can be advantageous in particular for producing carrier substrates with small dimensions.

Preferably, the carrier substrate can have a circumferential front side edge forming a transition from the carrier front side to an edge of the carrier substrate, and can have a circumferential rear side edge forming a transition from the carrier rear side to the edge of the carrier substrate.

It can be provided here that the front side edge has an average rounding radius which differs from the average rounding radius of the rear side edge, in particular differs by at least 0.5 mm.

It can be provided that the larger of the two average rounding radii is preferably less than 4 mm, particularly preferably is less than 2 mm, even more preferably is less than 1 mm, and wherein the larger of the two average rounding radii is preferably less than or equal to the thickness of the carrier substrate.

According to one embodiment of the invention, the carrier substrate can thus have an indentation on at least one side at at least one edge, said indentation being in particular larger than on the opposite side.

With regard to the heat conduction, it can be provided that the carrier substrate has a thermal conductivity λ which is greater than 100 W/mK, preferably is greater than 200 W/mK, particularly preferably is greater than 300 W/mK.

With regard to the material, it can be provided that the carrier substrate consists predominantly of a material which has a thermal conductivity λ which is greater than 100 W/mK, preferably is greater than 200 W/mK, particularly preferably is greater than 300 W/mK.

It can be provided for example that the carrier substrate comprises copper, in particular E-Cu (electrolytic copper) or Cu-ETP (electrolytic tough pitch) or OF-Cu (oxygen-free copper), and wherein the carrier substrate preferably consists predominantly of this material.

It can furthermore be provided that the carrier substrate, in particular the carrier front side, is provided with a coating, wherein the coating in particular comprises Ni or NiP, in particular comprises Ni and Au or comprises NiP and Au.

The connector situated between the carrier substrate and the light conversion element will be discussed again in more specific detail below.

With regard to the heat conduction, it can be provided that the connector has a thermal conductivity which is greater than 10 W/mK, preferably is greater than 30 W/mK, preferably is greater than 50 W/mK, and particularly preferably is greater than 100 W/mK.

The connector preferably has a thickness which is in the range of 1 μm to 100 μm, preferably is in the range of 1 μm or 5 μm to 50 μm, particularly preferably is in the range of 5 μm or 10 μm to 40 μm.

In some advantageous embodiments, the connector is embodied as a metallic solder or as a sintered sintering paste, wherein the solder preferably has a melting point below 300° C. and/or preferably comprises an Au/Sn solder and/or AuSn8020 or consists thereof.

The connector can also be embodied as a sintered sintering paste, preferably as an Ag-containing sintering paste.

Preferably, the sintered sintering paste has a layer thickness of 1 μm to 50 μm, with preference of 5 μm to 40 μm, preferably of 10 μm to 30 μm, particularly preferably of 15 μm to 25 μm.

Preferably, the sintered sintering paste has a thermal conductivity of at least 50 W/mK, preferably at least 100 W/mK, particularly preferably of at least 150 W/mK. Preferably, the sintered sintering paste has a porosity of less than 50%, preferably of less than 30%, particularly preferably of less than 10%.

The connector is arranged between the light conversion element and the carrier substrate in particular in such a way that the connector covers the rear side of the light conversion element over the whole area or covers a proportion thereof amounting to at least 75%, preferably at least 80%, particularly preferably at least 90%.

The connector can be arranged between the light conversion element and the carrier substrate in such a way that the plane defined by the carrier front side and the plane defined by the front side of the light conversion element run parallel or deviate by an angle of less than 10°, preferably less than 5°, particularly preferably 2°.

In particular, it is provided that the connector establishes a mechanically fixed connection between the carrier substrate, in particular the outermost coating of the carrier substrate, and the light conversion element, in particular the outermost coating of the light conversion element.

It can be provided that the adhesive strength of the light conversion element on the carrier substrate, which is ascertainable in particular by means of a shear test, e.g. according to MIL-STD-883F, test 2019.7, is preferably greater than 1 MPa, particularly preferably is greater than 10 MPa, even more preferably is greater than 50 MPa.

The light conversion element attached to the carrier substrate will be discussed again in more specific detail below.

The light conversion element preferably has a thickness which is in a range of 50 μm to 250 μm, preferably is in a range of 70 μm to 160 μm, particularly preferably is in a range of 70 μm to 110 μm.

It can be provided that the light conversion element has dimensions transversely with respect to its thickness which are in the range of 0.5 mm×0.5 mm to 20 mm×20 mm, preferably are in a range of 2 mm×2 mm to 5 mm×5 mm, particularly preferably be in a range of 3 mm×3 mm to 4 mm×4 mm, or has an equivalent dimension in terms of the area.

With regard to the heat conduction, the light conversion element can have a thermal conductivity which is greater than 1 W/mK, preferably is greater than 3 W/mK, particularly preferably is greater than 5 W/mK or particularly preferably is greater than 7 W/mK or is greater than 10 W/mK.

The light conversion element can comprise a material A₃B₅O₁₂, with A selected from the group of lanthanides and Ce, and B selected from Al and Ga. This includes the case where a plurality of elements of a group are selected, for example the material comprises both Y and Gd and Ce. A can thus correspond to one or more of the elements of the group. In particular, it can be provided that the light conversion element consists predominantly of such a material.

In some embodiments, the light conversion element furthermore comprises at least one further ceramic non-light-converting material, hereinafter also called “further ceramic material”, wherein the at least one further ceramic material has a higher thermal conductivity than the at least one light-converting ceramic material. Preferably, the at least one further ceramic material is Al₂O₃, Y₂O₃, YAlO₃, MgO, AlN, and/or SiN, preferably Al₂O₃.

The material of the light conversion element can be wholly or partly a ceramic, wherein this can also be referred to as an optoceramic. The material of the light conversion element can contain pores or other light-scattering inclusions or particles.

Preferably, the light conversion element comprises scattering centres, wherein the scattering centres preferably comprise pores or other light-scattering inclusions or particles, preferably pores.

Preferably, the light conversion element has a scattering coefficient s of 10 cm⁻¹ to 1000 cm⁻¹, preferably of 150 cm⁻¹ to 850 cm⁻¹, preferably of 250 cm⁻¹ to 600 cm⁻¹ at 600 nm.

The degree of optical scattering, described by the scattering coefficient s, influences (together with the absorption coefficient) in particular how large the proportion of converted backscattered, in particular blue, excitation radiation is, and also how far the excitation radiation diffuses within the light conversion element until complete absorption, and also how far the converted light diffuses within the light conversion element until it leaves the light conversion element again as useful light. Important indicators such as the efficiency of a component or the emission light spot size are influenced by the scattering. For remissive (irradiation and emission on the same side) lighting devices, a sufficiently large optical scattering coefficient is desired.

Preferably, the light conversion element comprises a multiplicity of pores, which preferably have a median of the diameters of 0.1 μm to 2 μm.

The median of the diameters of the pores, in particular of the pores located in a cross section, is preferably between 0.1 μm and 2 μm, preferably between 0.3 μm and 1.5 μm, particularly preferably between 0.4 μm and 1.2 μm.

The median divides a data set, or a sample or a distribution, in the present case for example the diameter of the pores in the cross section, into two equal parts such that the values, i.e. the pore diameters, are in the one half not greater than the median value and in the other not less.

Preferably, the light conversion element has a porosity in the range of 0.5% to 15%, preferably of 1% to 10%, particularly preferably of 2% to 6%.

The porosity P of the light conversion element can be ascertained using the following formula:

$$P = 1 - \frac{ρ}{{ρ}_{th}}$$

wherein ρₜₕ corresponds to the theoretical density of the at least one ceramic material of the light conversion element and ρ corresponds to the measured porosity of the light conversion element.

Details with regard to ascertaining the porosity and the median of the diameters of the pores can be taken, for example, from DE 10 2022 120 647 A.

The light conversion component can comprise one or more coatings.

In particular in embodiments in which the connector is a sintered sintering paste, it is advantageous for the surface of the light conversion element and the surface of the carrier substrate which are connected to one other to have a coating. Preferably, the light conversion element is provided with an Ag-containing thin-film layer, optionally additionally with an Au-containing thin-film layer, or coated with a Cu-containing thin-film layer or an Ag-containing thick-film layer. Preferred embodiments of the Ag-containing thin-film layer and the Au-containing thin-film layer and the Ag-containing thick-film layer are described below and are valid here accordingly. In advantageous embodiments, the surface of the carrier substrate has a coating, the coating preferably being an Au-containing coating and/or a NiP coating. Preferably, the surface of the carrier substrate is provided with a NiP layer, wherein the NiP layer preferably has a layer thickness of 1 μm to 10 μm, preferably 3 μm to 7 μm and/or wherein the Au layer preferably has a layer thickness of 50 nm to 500 nm, preferably 100 nm to 400 nm, preferably 150 nm to 300 nm.

In embodiments in which the connector is a sintered sintering paste, the light conversion element and the carrier substrate are connected according to the following steps:
a) providing a carrier substrate and a light conversion element;
b) applying the sintering paste at least on a part of the surface of the carrier substrate and/or at least on a part of the surface of the light conversion element;
c) contacting the surface of the carrier substrate and the surface of the light conversion element, with at least a part of the surface of the carrier substrate and/or at least a part of the surface of the light conversion element being covered with the sintering paste;
d) sintering the composite assembly obtained in step c).

In step a) of the method, a carrier substrate and a light conversion element are provided. Preferably, the surfaces of the substrate and/or of the light conversion element have the coatings described in more detail above.

In step b), a sintering paste is applied at least on a part of the surface of the carrier substrate and/or at least on a part of the surface of the light conversion element. Preferably, a sintering paste is applied at least on a part of the carrier substrate. Typically, the amount of sintering paste is metered such that, after the sintering step d), the sintered sintering paste has a layer thickness of 1 μm to 50 μm, preferably of 5 μm to 40 μm, preferably of 10 μm to 30 μm, particularly preferably of 15 μm to 25 μm.

In step c), the surface of the carrier substrate and the surface of the light conversion element, with at least a part of the surface of the carrier substrate and/or at least a part of the surface of the light conversion element being covered with the sintering paste, are contacted with each other. Preferably, the surface of the light conversion element is contacted with a part of the surface of the carrier substrate, with the part of the surface of the carrier substrate being at least partly covered with sintering paste. Advantageously, the contacting takes place with application of pressure, preferably at least 15 mN/mm², preferably more than 30 mN/mm², particularly preferably more than 60 mN/mm².

In step d), the composite assembly obtained in step d) is sintered. Sintering can take place under an oxygen-containing atmosphere or in air or under an inert gas atmosphere, in particular in an Ne or Ar atmosphere. Sintering takes place at temperatures in the range of 180° C. to 300° C.

Preferably, the sintering paste has a sintering temperature of not more than 300° C., preferably not more than 280° C., preferably not more than 250° C. Preferably, the sintering takes place by heating of the composite assembly to the desired sintering temperature, with heating advantageously in a first step up to a first temperature, at preferably at least 0.5 K/min, preferably at least 0.75 K/min and/or at not more than 3 K/min, preferably not more than 2 K/min. Preferably, the first temperature is in the range of 70° C. to 120° C., preferably 80° C. to 105° C. Preferably, after attainment of the first temperature, the temperature is held for 1 min to 60 min, preferably for 5 min to 45 min, preferably 20 min to 40 min. Preferably, in a second step, the composite assembly is subsequently heated up to a second temperature at preferably at least 1.0 K/min, preferably at least 1.5 K/min and/or not more than 3.5 K/min, preferably not more than 3 K/min. Preferably, the second temperature is in a range of 180° C. to 300° C., preferably 200° C. to 280° C., and corresponds to the sintering temperature. Preferably, after attainment of the second temperature, or the sintering temperature, the temperature is held for at least 10 min, preferably at least 20 min or at least 30 min and/or not longer than 60 min, preferably not longer than 50 min or 40 min. The composite assembly is thereafter cooled to preferably room temperature.

In some embodiments, the light conversion component has at least one highly reflective layer or coating, wherein the highly reflective layer or coating is preferably a metallic layer or coating and/or a dielectric layer or coating, particularly preferably an Ag or Ag-containing layer or coating.

It may be provided, for example, that the light conversion element has on its rear side an, in particular metallic, reflection layer, preferably comprising or composed of Ag, in particular such that the rear side of the light conversion element is coated with the reflection layer, and wherein the reflection layer is preferably applied by vapour deposition, sputtering (thin-film layer) or printing (thick-film layer) on the rear side of the light conversion element.

In one embodiment, the light conversion element has a reflection layer which is a thin-film layer. Preferably, the thin-film layer comprises Ag or consists thereof and/or has a layer thickness of 50 nm to 500 nm, preferably of 100 nm to 350 nm, further preferably of 125 nm to 300 nm, particularly preferably 150 nm to 250 nm. In some embodiments, the light conversion element has a thin-film layer comprising or consisting of Ag and a further thin-film layer comprising or consisting of Au. Preferably, the further thin-film layer is applied by means of vapour deposition or sputtering. Preferably, the thin-film layer comprising or consisting of Au has a layer thickness of 50 nm to 500 nm, preferably of 100 nm to 350 nm, further preferably of 125 nm to 300 nm, particularly preferably 150 nm to 250 nm. The thin-film layer comprising or consisting of Au can serve to protect the reflection layer comprising or consisting of Ag from oxidation reactions, above all at higher temperatures, which can prevail for example when connecting the light conversion element to the substrate, for example with a sintering paste.

In one embodiment, the light conversion element has a reflection layer which is an Ag-containing thick-film layer. Preferably, the thick-film layer has a layer thickness of 1 μm to 25 μm, preferably 5 μm to 20 μm, particularly preferably of 10 μm to 15 μm.

In some embodiments, the light conversion component comprises at least one optical separation layer, which is preferably located between the at least one highly reflective layer and the rear side of the light conversion element, wherein the at least one optical separation layer is preferably transparent and/or has a refractive index lower than the refractive index of the light conversion element, wherein the at least one optical separation layer preferably comprises SiO₂ or consists thereof, and
wherein the optical separation layer with preference has a thickness of less than 5 μm, preferably in the range of 0.5 μm to 1.5 μm, particularly preferably in the range of 0.8 μm to 1.2 μm.

The optical separation layer can be used to separate the reflection and, where appropriate, the total internal reflection of the secondary light reaching the rear side of the light conversion element (converter rear side) at the converter rear side from the reflection of the portion of the secondary light traversing the converter rear side at a highly reflective layer, in particular at a metallic mirror.

In some embodiments, the light conversion component has at least one adhesion promoter layer, which is preferably located between the at least one highly reflective layer and the optical separation layer, preferably comprising or consisting of one or more oxides selected from the group consisting of TiO₂, Y₂O₃, La₂O₃, SnO₂, preferably Y₂O₃. Preferably, the adhesion promoter layer has a thickness of 1 nm or more and/or less than 100 nm, preferably less than 75 nm, further preferably of less than 50 nm, preferably less than 35 nm and particularly preferably of less than 20 nm.

It can be provided that the light conversion element has on its front side a front side coating preferably formed as a mono- or multilayer anti-reflection coating.

The invention furthermore relates to a light conversion assembly comprising a light conversion component according to the above embodiments, a heat exchanger, on which the light conversion component is mounted, in particular manually exchangeable, and preferably a heat conducting medium introduced between the carrier substrate of the light conversion component and the heat exchanger.

It can be provided that the heat exchanger comprises fixing means configured to secure, e.g. fixedly screw or fixedly clamp, the light conversion component on the heat exchanger.

The fixing means of the heat exchanger can interact in particular with the fixing structure of the light conversion component.

The heat exchanger preferably has a thermal conductivity which is greater than 50 W/mK, preferably is greater than 200 W/mK, particularly preferably is greater than 350 W/mK.

The heat conducting medium is preferably introduced between the carrier substrate of the light conversion component and the heat exchanger in such a way that the heat conducting medium covers the rear side of the light conversion element over the whole area or covers a proportion thereof amounting to at least 75%.

The heat conducting medium can be formed as a heat conducting paste, heat conducting gel, heat conducting pad and/or heat conducting adhesive.

It can be provided that the heat exchanger comprises at least one of the following materials: aluminium, aluminium alloy, copper, brass, copper alloy, steel, silicon.

It can be provided that the heat exchanger comprises cooling fins or heat pipes.

A fan or pipes for the flow of cooling liquid or a Peltier cooler can be mounted at or on the heat exchanger.

The invention furthermore relates to a lighting device comprising a light conversion component or a light conversion assembly according to the above embodiments, and a light source, in particular embodied as a laser or light-emitting diode, for irradiating the front side of the light conversion element of the light conversion component with primary light.

It can be provided that the primary light generates on the front side of the light conversion element a luminous spot having a size in the range of 0.05 mm² to 20 mm², preferably having a size in the range of 0.1 mm² to 10 mm², particularly preferably having a size in the range of 0.2 mm² to 5 mm².

The ratio of the size of the luminous spot to the front side of the light conversion element can be in the range of 0.003 to 0.63, preferably be in the range of 0.006 to 0.6, particularly preferably be in the range of 0.01 to 0.5.

The carrier substrate can have a higher thermal conductivity than the heat exchanger, in particular at least by a factor of 1.2, preferably at least by a factor of 1.5, particularly preferably at least by a factor of 2.

The invention furthermore relates to a method for producing a light conversion component comprising the following steps: providing a carrier substrate, in particular by stamping the carrier substrate from a raw substrate, providing a light conversion element and applying the light conversion element on the carrier substrate, wherein a connector is arranged between the light conversion element and the carrier substrate, said connector establishing a mechanically fixed connection.

With regard to stamping and the associated features of the carrier substrate, reference is made to the explanations given above.

### BRIEF DESCRIPTION OF THE DRAWINGS

The invention will be explained in greater detail below on the basis of exemplary embodiments with reference to the figures. In the figures here:

FIG. 1: shows a schematic sectional view of a light conversion assembly with a light conversion component mounted on a heat exchanger,

FIGS. 2a, 2b, 2c, 2d: show schematic sectional views (upper row) and views of the front side (lower row) of various embodiments of light conversion components,

FIG. 3: shows a schematic view of the rear side (top), a sectional view (middle) and a view of the front side (bottom) of an embodiment of a light conversion component,

FIG. 4: shows a temperature distribution ascertained by means of numerical simulation for an embodiment of a light conversion component,

FIGS. 5a, 5b, 6a, 6b, 7a, 7b, 8a, 8b: show graphs of the temperature increase ΔT as a function of the characteristic height CH for various characteristic lengths CL (a) and as a function of the characteristic thermal resistance CHR (b), said graphs having been ascertained by means of numerical simulation for various embodiments of light conversion components,

FIGS. 9a, 9b, 9c, 9d: shows various exemplary embodiments of light conversion components.

### DETAILED DESCRIPTION

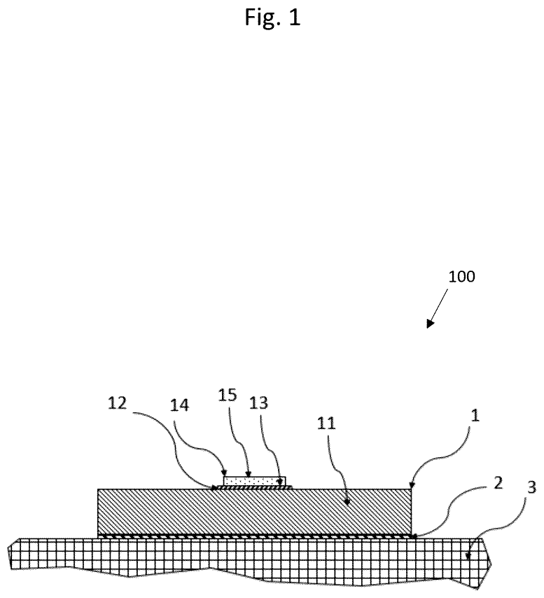

Referring to FIG. 1, an embodiment of a light conversion component 1 is shown, which is mounted on a heat exchanger 3, such that overall a light conversion assembly 100 is formed. The light conversion component 1 comprises a light conversion element 14, which can also be referred to as a converter, e.g. a small, square or rectangular or round platelet composed of light-converting material, which is fixedly connected to a carrier substrate 11, which can also be referred to as a heat spreader. A converter-heat spreader composite assembly is thus formed as a result. A fixed connection means in particular a very good thermal connection in order to be able to effectively transfer the heat generated in the converter platelet 14 owing to incomplete conversion to the heat spreader 11. However, a fixed connection also means in particular a mechanically fixed connection, i.e. a connection which cannot be separated by releasing reusable fixing means, e.g. screws or clamps.

In this example, the converter 14 is provided on the underside with a suitable reflective coating 13, which simultaneously enables mechanical and thermal contact with the heat spreader 11 via a suitable connector 12. The surface of the converter 14 can have an anti-reflection layer 15. Consequently, while the top side of the converter 14 preferably has an anti-reflection coating 15, the rear side can be provided with a reflective coating 13, which is e.g. at the same time thermally conductive and mechanically fixedly connectable to the heat spreader 11.

The heat spreader 11 and thus the entire light conversion component 1, i.e. the entire converter-heat spreader composite assembly, can be mounted for the respective application on a heat exchanger 3, also referred to as a heat sink. A releasable connection by means of clamps or screws is generally used in this case. In order to improve the heat transfer between heat spreader 11 and heat exchanger 3, a heat conducting paste 2, e.g. also referred to as “thermal grease”, can be located therebetween in order to compensate for unevenness of the surfaces situated one on top of the other. Fixed connections by means of adhesive bonding, soldering or silver sintering are also possible.

The heat spreader 11 carries for example a, e.g. rectangular or square, converter 14 having side lengths e.g. in the range of approx. 0.5 mm to several mm, for example 0.5 mm×0.9 mm or 1.2 mm×1.4 mm or 3 mm×3 mm or 4 mm×4 mm or the like. For example, the thickness of the converter 14 is between 50 μm and 500 μm, e.g. at 80 μm. In lighting devices comprising a laser, the diameter of a, e.g. blue, laser beam at the focus on the converter 14 is preferably upwardly limited by the size of the converter 14. For example, it can be provided that the size of the laser spot, the so-called spot size, is maximally of the same size as the converter 14. The laser light penetrates into the converter platelet 14 and is largely absorbed there. The unconverted portion of the absorbed optical power is converted into heat. This heat is dissipated to the heat spreader 11, on which the converter platelet 14 is mounted.

The heat spreader is preferably designed such that it can be mounted, preferably releasably, on a heat exchanger, e.g. by screws or clamps. A fixed connection is likewise possible, e.g. by adhesive bonding, soldering, or silver sintering. The heat spreader 11 can be at least of the same size laterally as the converter 14 located thereon; for simple handling it can be advantageous if the heat spreader is larger or even significantly larger. For this reason, in many embodiments, it can be assumed that the concrete size of the laser light spot, and thus the diameter of the heat source, which is sometimes already significantly smaller than the dimensions of the converter 14, is very much smaller than the dimensions of the heat spreader 11.

The material of the heat spreader 11 is e.g. copper in the purest form possible, e.g. so-called “E-Cu” or “Cu-ETP” or else “OF-Cu”. This has the advantage of a very high thermal conductivity on the one hand and the possibility of highly thermally conductive connections to the converter platelet, e.g. by soldering or silver sintering. In order to facilitate these connections even better, the heat spreader can also be plated with Ni or NiP; this “plating” can also be gold-plated for corrosion protection reasons.

The material copper, especially when plated as well, is relatively expensive, and so in cost-sensitive areas a minimum volumetric use of this material is sought. Just a limited structural volume may also be the reason for the smallest possible heat spreader. On the other hand, however, the heat spreader must be large enough to adequately fulfil the thermotechnical effect. It can be stated in simple terms that it is desirable to make the heat spreader as small as possible but as large as necessary.

The design and/or geometry of a carrier substrate 11, i.e. a heat spreader, can vary in diverse ways.

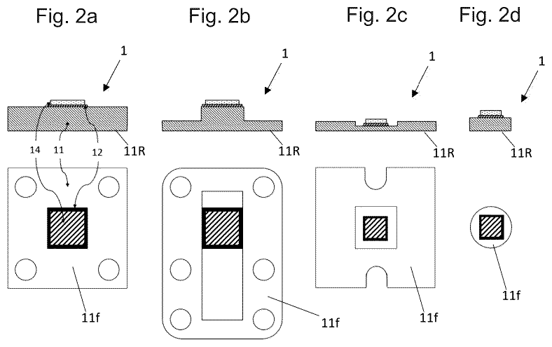

FIGS. 2a, 2b, 2c, and 2d shows various examples of light conversion components 1 having a differently designed carrier substrate 11. The light conversion components 1 and/or their carrier substrates 11 are configured to be applied on a heat exchanger by the carrier rear side 11R. In other words, the cooling, i.e. the connection to a heat exchanger, takes place via the opposite side of the heat spreader 11 with respect to the converter 14. The carrier rear side is accordingly preferably planar.

FIGS. 2a, 2b and 2c show examples with a carrier substrate 11 which in a linear dimension is larger than double or larger than triple the light conversion element 14 applied thereon. However, in the linear dimension the carrier substrate is in each case smaller than eight times or smaller than five times the light conversion element 14. FIG. 2d shows an example with a carrier substrate 11 which in a linear dimension is even smaller than triple the light conversion element 14 applied thereon.

In the examples shown, however, the carrier substrates 11 each have on their front side a free area 11f, which is not covered by the converter 14. In this free area 11f, a mounting structure can be provided in order to releasably mount the carrier substrate on a heat exchanger.

In the examples in FIGS. 2a and 2b, through holes are provided for this purpose, said through holes extending from the carrier front side to the carrier rear side and enabling a screw connection, for example. In the example in FIG. 2c, outwardly open recesses are provided for this purpose, said recesses likewise enabling a screw connection. The example shown in FIG. 2c accordingly forms a ‘simply connected’ form in the mathematical-topological sense, since no through holes are present. In the example in FIG. 2d, a free area is likewise provided, said region forming a mounting structure, which is releasably securable on a heat exchanger e.g. by clamping. The carrier substrates 11 shown in FIGS. 2c and 2d have only an outwardly oriented edge owing to the absence of through holes. This is advantageous for production by stamping methods. The example shown in FIG. 2d even has an outwardly oriented edge without recesses, which can again foster production by stamping.

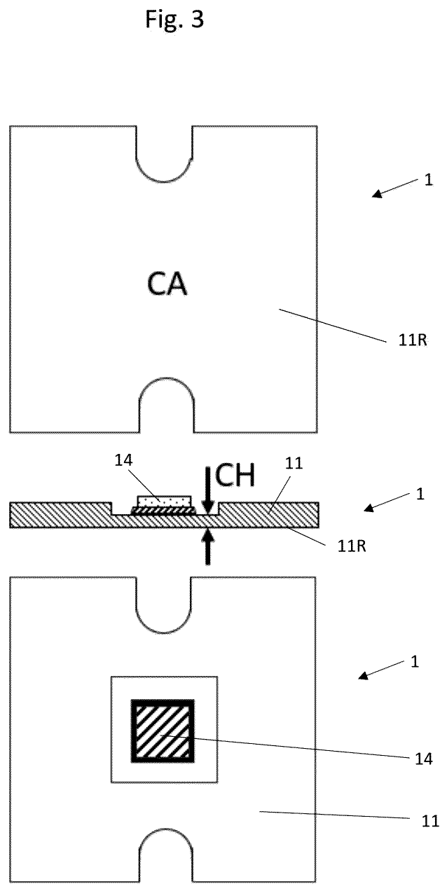

FIG. 3 shows once again various views of a light conversion component 11 corresponding e.g. to the variant shown in FIG. 2c. The area CA of the carrier rear side 11R which can be brought into contact or is in contact with the heat exchanger is a relevant aspect for heat dissipation. Typically, CA is the total surface area of the carrier rear side. However, in particular the surface area of the contact region between the carrier rear side and the heat exchanger can also be used when the carrier substrate is mounted on the heat exchanger.

A further relevant aspect is the distance CH between the light conversion element 14 and the carrier rear side 11R, i.e. in particular the distance between the converter 14 and the cooling, opposite, side, i.e. in particular the height of the heat spreader CH under the converter. Typically, CH is thus the thickness of the carrier substrate 11, in particular at the position at which the carrier substrate 11 carries the light conversion element 14. However, it is also possible to use in particular the distance between the position on the carrier front side which corresponds to the geometric centroid of the converter and the geometric centroid of the carrier rear side or the contact region between the carrier rear side and the heat exchanger, when the carrier substrate is mounted on the heat exchanger.

Temperature distributions were ascertained by means of numerical simulation in order to optimize the heat dissipation within a converter-heat spreader composite assembly 1. Optimized dimensions of the heat spreader 11 in the light conversion component 1, for example, may play a part here. The model used and its evaluation are described in V. Hagemann, A. Seidl, G. Weidmann: Static ceramic phosphor assemblies for high power high luminance SSL-light sources for digital projection and specialty lighting. Proc. of SPIE Vol. 11302 113021N-11, SPIE OPTO, San Francisco 2020.

The model is axially symmetric. For this purpose, any non-round (e.g. square or rectangular) lateral dimensions of converter platelets 14 or heat spreaders 11 are converted to circular converter platelets 14 or heat spreaders 11 with the same surface area. To put it another way: the real contact areas between the real converter platelet and heat spreader or between the real heat spreader and heat exchanger determine the diameter of converter platelet 14 and heat spreader 11 in the axially symmetric simulation.

As an example, a converter platelet having the dimensions 4 mm×4 mm×0.1 mm was considered, provided on the front side with an anti-reflection layer, reflectively coated on the rear side by means of printed silver, and connected to an E-Cu heat spreader by means of AuSn8020 solder with the thickness of 30 μm. The converter platelet consists of Ce:YAG ceramic having a specific Ce content, here: [Ce]=0.36 at %. In the simulations, the dimensions, i.e. diameter and height, of the heat spreader were varied. In the context of such comparisons, in particular the exact absorption and conversion properties can be left open.

It was further assumed as an example that the heat exchanger can maintain a temperature of 30° C. in the mounting region of the heat spreader. This can be achieved in the concrete case e.g. by suitable fans in a housing, or by water cooling in the heat exchanger, or by Peltier elements, or else in some other way.

The heat transfer coefficients between the heat spreader and the heat exchanger were defined as follows.

Typically, when connecting a heat spreader to a heat exchanger, for example by screwing or clamping it thereon, a heat conducting paste is applied in between. In particular, this paste compensates for the incomplete and poorly defined surface contact between the two solid surfaces. It is assumed that, depending on the pressure applied, a layer thickness of a paste d_{P} of e.g. at best 25 μm is achievable. Typical heat conducting pastes have e.g. a thermal conductivity λ_{P} of 4 W/mK or less. The heat transfer coefficient HTC thereby achievable is calculated as follows:

$$HTC = {λ}_{P} / {d}_{P}$$

Assuming the limit value mentioned above, that means HTC<0.16 W/mm²K. The comparative simulations were carried out in particular under the assumption of HTC=0.16 W/mm²K, but also for a smaller value of 0.08 W/mm²K and a larger value of 1 W/mm²K, which can be regarded e.g. as an almost perfect heat transfer.

Furthermore, a laser focus diameter Dₗₐₛ of 1.0 mm on the converter and a top-hat beam profile, i.e. a uniform intensity over the radius, were assumed for the simulations. The optical power Pₗₐₛ of the incident laser beam was set uniformly to 10 W.

The heat spreader can be described as follows. The characteristic height CH corresponds in particular to the height of the heat spreader under the converter, i.e. the distance between the underside and top side of the heat spreader under the converter. The characteristic area CA is that area of the underside of the heat spreader which is used for contact with the heat exchanger. A characteristic length CL can be defined as the diameter of the area CA assumed to be circular, i.e. axially symmetric,

$$CL = 2 \cdot {( CA / Π )}^{0.5}$$

The thermal conductivity of the heat spreader can be designated as λ. In particular the thermal conductivity of E-Cu (390 W/mK), and for comparison also a lower thermal conductivity of 200 W/mK, were assumed for the simulations.

A characteristic thermal resistance of the heat spreader CHR can thus be defined as

$$CHR = CH / λ / CA$$

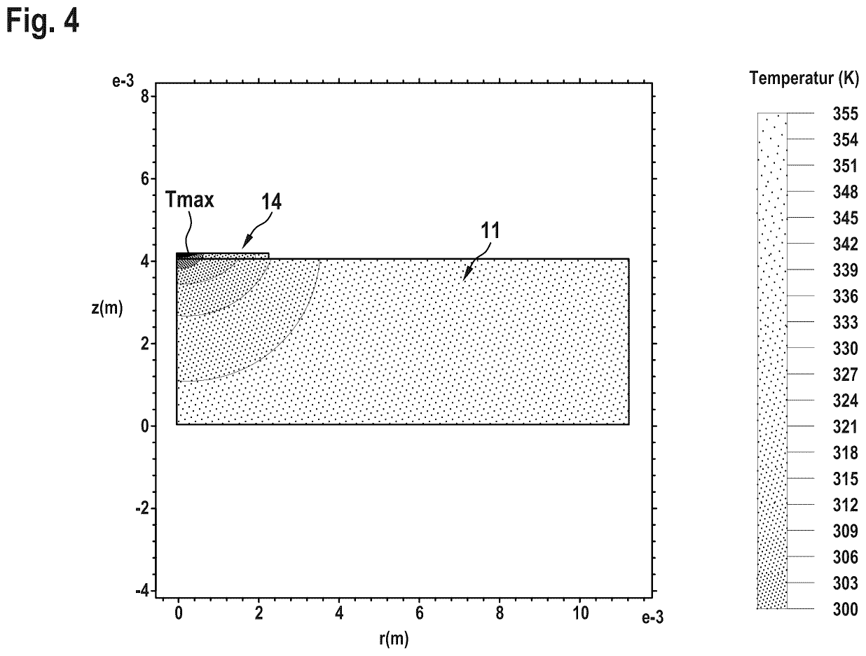

FIG. 4 shows a resulting temperature distribution, which was ascertained by means of simulation in the converter-heat spreader composite assembly 1. That is based on the case of a heat spreader of the format CH=4 mm, CA=400 mm² and also λ=390 W/mK and HTC=0.16 W/mm²K (see also Tab. 1).

The maximum temperature Tₘₐₓ respectively established in the converter platelet 14 is then used for comparison (monitor point). The difference with respect to the temperature of the heat exchanger T_{ref} is the temperature increase ΔT.

If only parameters that characterize the heat spreader 11 (CH, CL, λ and thus also the variable CHR) are then varied, the temperature increase ΔT changes.

In Tab. 1, calculated variations with the respective result of the simulation are listed for the case λ=390 W/mK and HTC=0.16 W/mm²K. Tab. 2-4 show the same for variations of λ and HTC.

Tab. 1 below: Maximum temperature, calculated by means of numerical simulation, in the converter Tₘₐₓ for heat spreaders of various dimensions, for the case λ=390 W/mK and HTC=0.16 W/mm²K.

| D [symbol] [mm] | P [symbol] [W] | HTC [W/mm [symbol] K] | λ [W/mmK] | T_{ref} [K] | CH [mm] | CA [mm²] | CL [mm] | T [symbol] [K] | ΔT [K] | CHR [K/W] |
|---|---|---|---|---|---|---|---|---|---|---|
| 1 | 10 | 0.16 | 0.39 | 303.15 | 12 | 1600 | 45.1 | 355.2 | 52.050 | 0.019 |
| 1 | 10 | 0.16 | 0.39 | 303.15 | 8 | 1600 | 45.1 | 354.9 | 51.750 | 0.013 |
| 1 | 10 | 0.16 | 0.39 | 303.15 | 4 | 1600 | 45.1 | 354.3 | 51.150 | 0.006 |
| 1 | 10 | 0.16 | 0.39 | 303.15 | 2 | 1600 | 45.1 | 354.0 | 50.850 | 0.003 |
| 1 | 10 | 0.16 | 0.39 | 303.15 | 1 | 1600 | 45.1 | 354.3 | 51.150 | 0.002 |
| 1 | 10 | 0.16 | 0.39 | 303.15 | 0.5 | 1600 | 45.1 | 355.6 | 52.450 | 0.001 |
| 1 | 10 | 0.16 | 0.39 | 303.15 | 0.25 | 1600 | 45.1 | 357.7 | 54.550 | 0.000 |
| 1 | 10 | 0.16 | 0.39 | 308.15 | 0.125 | 1600 | 45.1 | 360.3 | 57.150 | 0.000 |
| 1 | 10 | 0.16 | 0.39 | 303.15 | 12 | 400 | 22.6 | 356.3 | 53.150 | 0.077 |
| 1 | 10 | 0.16 | 0.39 | 303.15 | 8 | 400 | 22.6 | 355.4 | 52.250 | 0.051 |
| 1 | 10 | 0.16 | 0.39 | 308.15 | 4 | 400 | 22.6 | 354.4 | 51.250 | 0.026 |
| 1 | 10 | 0.16 | 0.39 | 303.15 | 2 | 400 | 22.6 | 354.0 | 50.850 | 0.013 |
| 1 | 10 | 0.16 | 0.39 | 303.15 | 1 | 400 | 22.6 | 354.3 | 51.150 | 0.006 |
| 1 | 10 | 0.16 | 0.39 | 303.15 | 0.5 | 400 | 22.6 | 355.6 | 52.450 | 0.003 |
| 1 | 10 | 0.16 | 0.39 | 303.15 | 0.25 | 400 | 22.6 | 357.7 | 54.550 | 0.002 |
| 1 | 10 | 0.16 | 0.39 | 303.15 | 0.125 | 400 | 22.6 | 360.3 | 57.150 | 0.001 |
| 1 | 10 | 0.16 | 0.39 | 303.15 | 12 | 100 | 11.3 | 363.4 | 60.250 | 0.308 |
| 1 | 10 | 0.16 | 0.39 | 303.15 | 8 | 100 | 11.3 | 359.7 | 56.550 | 0.205 |
| 1 | 10 | 0.16 | 0.39 | 303.15 | 4 | 100 | 11.3 | 356.1 | 52.950 | 0.103 |
| 1 | 10 | 0.16 | 0.39 | 303.15 | 2 | 100 | 11.3 | 354.5 | 51.350 | 0.051 |
| 1 | 10 | 0.16 | 0.39 | 303.15 | 1 | 100 | 11.3 | 354.4 | 51.250 | 0.026 |
| 1 | 10 | 0.16 | 0.39 | 303.15 | 0.5 | 100 | 11.3 | 355.6 | 52.450 | 0.013 |
| 1 | 10 | 0.16 | 0.39 | 303.15 | 0.25 | 100 | 11.3 | 357.7 | 54.550 | 0.006 |
| 1 | 10 | 0.16 | 0.39 | 303.15 | 0.125 | 100 | 11.3 | 360.3 | 57.150 | 0.003 |
| 1 | 10 | 0.16 | 0.39 | 303.15 | 12 | 49 | 7.9 | 374.8 | 71.650 | 0.628 |
| 1 | 10 | 0.16 | 0.39 | 303.15 | 8 | 49 | 7.9 | 367.3 | 64.150 | 0.419 |
| 1 | 10 | 0.16 | 0.39 | 303.15 | 4 | 49 | 7.9 | 359.9 | 56.750 | 0.209 |
| 1 | 10 | 0.16 | 0.39 | 303.15 | 2 | 49 | 7.9 | 356.3 | 53.150 | 0.105 |
| 1 | 10 | 0.16 | 0.39 | 303.15 | 1 | 49 | 7.9 | 355.1 | 51.950 | 0.052 |
| 1 | 10 | 0.16 | 0.39 | 303.15 | 0.5 | 49 | 7.9 | 355.8 | 52.650 | 0.026 |
| 1 | 10 | 0.16 | 0.39 | 303.15 | 0.25 | 49 | 7.9 | 357.7 | 54.550 | 0.013 |
| 1 | 10 | 0.16 | 0.39 | 303.15 | 0.125 | 49 | 7.9 | 360.3 | 57.150 | 0.007 |

[symbol]

indicates data missing or illegible when filed

Tab. 2 below: Maximum temperature, calculated by means of numerical simulation, in the converter Tₘₐₓ for heat spreaders of various dimensions, for the case λ=390 W/mK and HTC=0.08 W/mm²K.

| D [symbol] [mm] | P [symbol] [W] | HTC [W/mm²K] | λ [W/mmK] | T_{ref} [K] | CH [mm] | CA [mm²] | CL [mm] | T [symbol] [K] | ΔT [K] | CHR [K/W] |
|---|---|---|---|---|---|---|---|---|---|---|
| 1 | 10 | 0.08 | 0.39 | 303.15 | 12 | 1600 | 45.1 | 355.4 | 52.250 | 0.019 |
| 1 | 10 | 0.08 | 0.39 | 303.15 | 8 | 1600 | 45.1 | 355.1 | 51.950 | 0.013 |
| 1 | 10 | 0.08 | 0.39 | 303.15 | 4 | 1600 | 45.1 | 354.9 | 51.750 | 0.006 |
| 1 | 10 | 0.08 | 0.39 | 303.15 | 2 | 1600 | 45.1 | 355.4 | 52.250 | 0.003 |
| 1 | 10 | 0.08 | 0.39 | 303.15 | 1 | 1600 | 45.1 | 357.4 | 54.250 | 0.002 |
| 1 | 10 | 0.08 | 0.39 | 303.15 | 0.5 | 1600 | 45.1 | 361.1 | 57.950 | 0.001 |
| 1 | 10 | 0.08 | 0.39 | 303.15 | 0.25 | 1600 | 45.1 | 366.3 | 63.150 | 0.000 |
| 1 | 10 | 0.08 | 0.39 | 303.15 | 0.125 | 1600 | 45.1 | 372.3 | 69.150 | 0.000 |
| 1 | 10 | 0.08 | 0.39 | 303.15 | 12 | 400 | 22.6 | 356.8 | 53.650 | 0.077 |
| 1 | 10 | 0.08 | 0.39 | 303.15 | 8 | 400 | 22.6 | 355.9 | 52.750 | 0.051 |
| 1 | 10 | 0.08 | 0.39 | 303.15 | 4 | 400 | 22.6 | 355.2 | 52.050 | 0.026 |
| 1 | 10 | 0.08 | 0.39 | 303.15 | 2 | 400 | 22.6 | 355.5 | 52.350 | 0.013 |
| 1 | 10 | 0.08 | 0.39 | 303.15 | 1 | 400 | 22.6 | 357.4 | 54.250 | 0.006 |
| 1 | 10 | 0.08 | 0.39 | 303.15 | 0.5 | 400 | 22.6 | 361.1 | 57.950 | 0.003 |
| 1 | 10 | 0.08 | 0.39 | 303.15 | 0.25 | 400 | 22.6 | 366.3 | 6 [symbol] .150 | 0.002 |
| 1 | 10 | 0.08 | 0.39 | 303.15 | 0.125 | 400 | 22.6 | 372.3 | 69.150 | 0.001 |
| 1 | 10 | 0.08 | 0.39 | 303.15 | 12 | 100 | 11.3 | 365.6 | 62.450 | 0.308 |
| 1 | 10 | 0.08 | 0.39 | 303.15 | 8 | 100 | 11.3 | 362.0 | 58.850 | 0.205 |
| 1 | 10 | 0.08 | 0.39 | 303.15 | 4 | 100 | 11.3 | 358.3 | 55.150 | 0.103 |
| 1 | 10 | 0.08 | 0.39 | 303.15 | 2 | 100 | 11.3 | 357.0 | 53.850 | 0.051 |
| 1 | 10 | 0.08 | 0.39 | 303.15 | 1 | 100 | 11.3 | 357.9 | 54.750 | 0.026 |
| 1 | 10 | 0.08 | 0.39 | 303.15 | 0.5 | 100 | 11.3 | 361.2 | 58.050 | 0.013 |
| 1 | 10 | 0.08 | 0.39 | 303.15 | 0.25 | 100 | 11.3 | 366.3 | 63.150 | 0.006 |
| 1 | 10 | 0.08 | 0.39 | 303.15 | 0.125 | 100 | 11.3 | 372.3 | 69.150 | 0.003 |
| 1 | 10 | 0.08 | 0.39 | 303.15 | 12 | 49 | 7.9 | 379.3 | 76.150 | 0.628 |
| 1 | 10 | 0.08 | 0.39 | 303.15 | 8 | 49 | 7.9 | 371.9 | 68.750 | 0.419 |
| 1 | 10 | 0.08 | 0.39 | 303.15 | 4 | 49 | 7.9 | 364.4 | 61.250 | 0.209 |
| 1 | 10 | 0.08 | 0.39 | 303.15 | 2 | 49 | 7.9 | 360.9 | 57.750 | 0.105 |
| 1 | 10 | 0.08 | 0.39 | 303.15 | 1 | 49 | 7.9 | 360.2 | 57.050 | 0.052 |
| 1 | 10 | 0.08 | 0.39 | 303.15 | 0.5 | 49 | 7.9 | 362.2 | 59.050 | 0.026 |
| 1 | 10 | 0.08 | 0.39 | 303.15 | 0.25 | 49 | 7.9 | 366.6 | 63.450 | 0.013 |
| 1 | 10 | 0.08 | 0.39 | 303.15 | 0.125 | 49 | 7.9 | 372.4 | 69.250 | 0.007 |

[symbol]

indicates data missing or illegible when filed

Tab. 3 below: Maximum temperature, calculated by means of numerical simulation, in the converter Tₘₐₓ for heat spreaders of various dimensions, for the case λ=390 W/mK and HTC=1 W/mm²K.

| D [symbol] [mm] | P [symbol] [W] | HTC [W/mm²K] | λ [W/mmK] | T_{ref} [K] | CH [mm] | CA [mm²] | CL [mm] | T [symbol] [K] | ΔT [K] | CHR [K/W] |
|---|---|---|---|---|---|---|---|---|---|---|
| 1 | 10 | 1 | 0.39 | 303.15 | 12 | 1600 | 45.1 | 355.0 | 51.850 | 0.019 |
| 1 | 10 | 1 | 0.39 | 303.15 | 8 | 1600 | 45.1 | 354.6 | 51.450 | 0.013 |
| 1 | 10 | 1 | 0.39 | 303.15 | 4 | 1600 | 45.1 | 353.6 | 50.450 | 0.006 |
| 1 | 10 | 1 | 0.39 | 303.15 | 2 | 1600 | 45.1 | 351.9 | 48.750 | 0.003 |
| 1 | 10 | 1 | 0.39 | 303.15 | 1 | 1600 | 45.1 | 349.7 | 46.550 | 0.002 |
| 1 | 10 | 1 | 0.39 | 303.15 | 0.5 | 1600 | 45.1 | 347.7 | 44.550 | 0.001 |
| 1 | 10 | 1 | 0.39 | 303.15 | 0.25 | 1600 | 45.1 | 346.4 | 43.250 | 0.000 |
| 1 | 10 | 1 | 0.39 | 303.15 | 0.125 | 1600 | 45.1 | 345.7 | 42.550 | 0.000 |
| 1 | 10 | 1 | 0.39 | 303.15 | 12 | 400 | 22.6 | 355.8 | 52.6 [symbol] 0 | 0.077 |
| 1 | 10 | 1 | 0.39 | 303.15 | 8 | 400 | 22.6 | 354.9 | 51.750 | 0.051 |
| 1 | 10 | 1 | 0.39 | 303.15 | 4 | 400 | 22.6 | 353.6 | 50.450 | 0.026 |
| 1 | 10 | 1 | 0.39 | 303.15 | 2 | 400 | 22.6 | 351.9 | 48.750 | 0.013 |
| 1 | 10 | 1 | 0.39 | 303.15 | 1 | 400 | 22.6 | 349.7 | 46.550 | 0.006 |
| 1 | 10 | 1 | 0.39 | 303.15 | 0.5 | 400 | 22.6 | 347.7 | 44.550 | 0.003 |
| 1 | 10 | 1 | 0.39 | 303.15 | 0.25 | 400 | 22.6 | 346.4 | 43.250 | 0.002 |
| 1 | 10 | 1 | 0.39 | 303.15 | 0.125 | 400 | 22.6 | 345.7 | 42.550 | 0.001 |
| 1 | 10 | 1 | 0.39 | 303.15 | 12 | 100 | 11.3 | 361.5 | 58.350 | 0.308 |
| 1 | 10 | 1 | 0.39 | 303.15 | 8 | 100 | 11.3 | 357.9 | 54.750 | 0.205 |
| 1 | 10 | 1 | 0.39 | 303.15 | 4 | 100 | 11.3 | 354.2 | 51.050 | 0.103 |
| 1 | 10 | 1 | 0.39 | 303.15 | 2 | 100 | 11.3 | 351.9 | 48.750 | 0.051 |
| 1 | 10 | 1 | 0.39 | 303.15 | 1 | 100 | 11.3 | 349.7 | 46.550 | 0.026 |
| 1 | 10 | 1 | 0.39 | 303.15 | 0.5 | 100 | 11.3 | 347.7 | 44.550 | 0.013 |
| 1 | 10 | 1 | 0.39 | 303.15 | 0.25 | 100 | 11.3 | 346.4 | 43.250 | 0.006 |
| 1 | 10 | 1 | 0.39 | 303.15 | 0.125 | 100 | 11.3 | 345.7 | 42.550 | 0.003 |
| 1 | 10 | 1 | 0.39 | 303.15 | 12 | 49 | 7.9 | 371.0 | 67.850 | 0.528 |
| 1 | 10 | 1 | 0.39 | 303.15 | 8 | 49 | 7.9 | 363.5 | 60.350 | 0.419 |
| 1 | 10 | 1 | 0.39 | 303.15 | 4 | 49 | 7.9 | 356.1 | 52.950 | 0.209 |
| 1 | 10 | 1 | 0.39 | 303.15 | 2 | 49 | 7.9 | 352.2 | 49.050 | 0.105 |
| 1 | 10 | 1 | 0.39 | 303.15 | 1 | 49 | 7.9 | 349.7 | 46.550 | 0.052 |
| 1 | 10 | 1 | 0.39 | 303.15 | 0.5 | 49 | 7.9 | 347.7 | 44.550 | 0.026 |
| 1 | 10 | 1 | 0.39 | 303.15 | 0.25 | 49 | 7.9 | 346.4 | 43.250 | 0.013 |
| 1 | 10 | 1 | 0.39 | 303.15 | 0.125 | 49 | 7.9 | 345.7 | 42.550 | 0.007 |

[symbol]

indicates data missing or illegible when filed

Tab. 4 below: Maximum temperature, calculated by means of numerical simulation, in the converter Tₘₐₓ for heat spreaders of various dimensions, for the case λ=200 W/mK and HTC=0.16 W/mm²K.

| D [symbol] [mm] | P [symbol] [W] | HTC [W/mm²K] | λ [W/mmK] | T [symbol] [K] | CH [mm] | CA [mm²] | CL [mm] | T [symbol] [K] | ΔT [K] | CHR [K/W] |
|---|---|---|---|---|---|---|---|---|---|---|
| 1 | 10 | 0.16 | 0.2 | 303.15 | 12 | 1600 | 45.1 | 369.6 | 66.450 | 0.038 |
| 1 | 10 | 0.16 | 0.2 | 303.15 | 8 | 1600 | 45.1 | 368.9 | 65.750 | 0.025 |
| 1 | 10 | 0.16 | 0.2 | 303.15 | 4 | 1600 | 45.1 | 367.3 | 64.150 | 0.013 |
| 1 | 10 | 0.16 | 0.2 | 303.15 | 2 | 1600 | 45.1 | 365.4 | 62.250 | 0.006 |
| 1 | 10 | 0.16 | 0.2 | 303.15 | 1 | 1600 | 45.1 | 363.7 | 60.550 | 0.003 |
| 1 | 10 | 0.16 | 0.2 | 303.15 | 0.5 | 1600 | 45.1 | 363.0 | 59.850 | 0.002 |
| 1 | 10 | 0.16 | 0.2 | 303.15 | 0.25 | 1600 | 45.1 | 363.3 | 60.150 | 0.001 |
| 1 | 10 | 0.16 | 0.2 | 303.15 | 0.125 | 1600 | 45.1 | 364.7 | 61.550 | 0.000 |
| 1 | 10 | 0.16 | 0.2 | 303.15 | 12 | 400 | 22.6 | 371.3 | 68.150 | 0.150 |
| 1 | 10 | 0.16 | 0.2 | 303.15 | 8 | 400 | 22.6 | 369.5 | 66.350 | 0.100 |
| 1 | 10 | 0.16 | 0.2 | 303.15 | 4 | 400 | 22.6 | 367.4 | 64.250 | 0.050 |
| 1 | 10 | 0.16 | 0.2 | 303.15 | 2 | 400 | 22.6 | 365.4 | 62.250 | 0.025 |
| 1 | 10 | 0.16 | 0.2 | 303.15 | 1 | 400 | 22.6 | 363.7 | 60.550 | 0.013 |
| 1 | 10 | 0.16 | 0.2 | 303.15 | 0.5 | 400 | 22.6 | 363.0 | 59.850 | 0.006 |
| 1 | 10 | 0.16 | 0.2 | 303.15 | 0.25 | 400 | 22.6 | 363.3 | 60.150 | 0.003 |
| 1 | 10 | 0.16 | 0.2 | 303.15 | 0.125 | 400 | 22.6 | 364.7 | 61.550 | 0.002 |
| 1 | 10 | 0.16 | 0.2 | 303.15 | 12 | 100 | 11.3 | 383.4 | 80.250 | 0.600 |
| 1 | 10 | 0.16 | 0.2 | 303.15 | 8 | 100 | 11.3 | 376.4 | 73.250 | 0.400 |
| 1 | 10 | 0.16 | 0.2 | 303.15 | 4 | 100 | 11.3 | 369.3 | 66.150 | 0.200 |
| 1 | 10 | 0.16 | 0.2 | 303.15 | 2 | 100 | 11.3 | 365.7 | 62.550 | 0.100 |
| 1 | 10 | 0.16 | 0.2 | 303.15 | 1 | 100 | 11.3 | 363.7 | 60.550 | 0.050 |
| 1 | 10 | 0.16 | 0.2 | 303.15 | 0.5 | 100 | 13.3 | 363.0 | 59.850 | 0.025 |
| 1 | 10 | 0.16 | 0.2 | 303.15 | 0.25 | 100 | 11.3 | 363.3 | 60.150 | 0.013 |
| 1 | 10 | 0.16 | 0.2 | 303.15 | 0.125 | 100 | 11.3 | 364.7 | 61.550 | 0.006 |
| 1 | 10 | 0.16 | 0.2 | 303.15 | 12 | 49 | 7.9 | 403.2 | 100.050 | 1.224 |
| 1 | 10 | 0.16 | 0.2 | 303.15 | 8 | 49 | 7.9 | 388.9 | 85.750 | 0.816 |
| 1 | 10 | 0.16 | 0.2 | 303.15 | 4 | 49 | 7.9 | 374.6 | 71.450 | 0.408 |
| 1 | 10 | 0.16 | 0.2 | 303.15 | 2 | 49 | 7.9 | 367.4 | 64.250 | 0.204 |
| 1 | 10 | 0.16 | 0.2 | 303.15 | 1 | 49 | 7.9 | 364.1 | 60.950 | 0.102 |
| 1 | 10 | 0.16 | 0.2 | 303.15 | 0.5 | 49 | 7.9 | 363.0 | 59.850 | 0.051 |
| 1 | 10 | 0.16 | 0.2 | 303.15 | 0.25 | 49 | 7.9 | 363.3 | 60.150 | 0.026 |
| 1 | 10 | 0.16 | 0.2 | 303.15 | 0.125 | 49 | 7.9 | 364.7 | 61.550 | 0.013 |

[symbol]

indicates data missing or illegible when filed

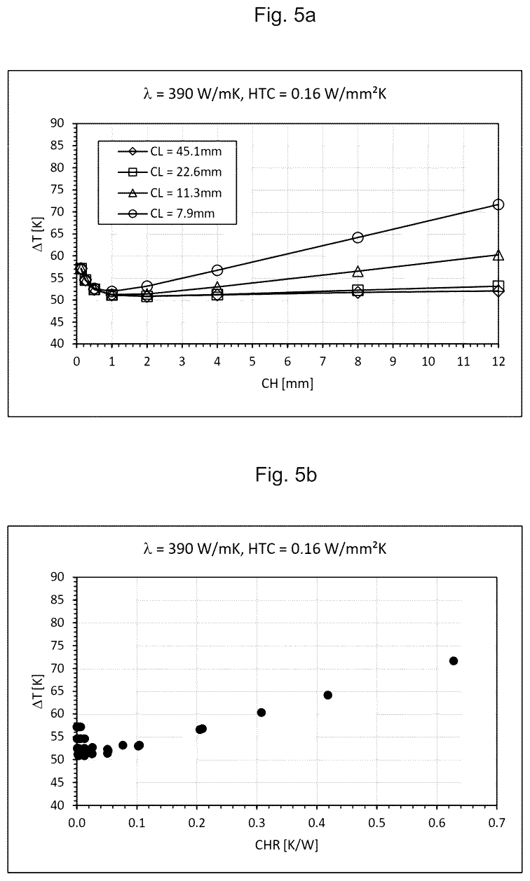

FIG. 5a shows the temperature increase at the monitor point ΔT as a function of the characteristic height CH of the heat spreader for various characteristic lengths CL of the heat spreader, for the case λ=390 W/mK and HTC=0.16 W/mm²K.

FIG. 5b shows for the same case ΔT as a function of the characteristic thermal resistance CHR of the heat spreader, i.e. the temperature increase at the monitor point ΔT as a function of the characteristic thermal resistance CHR, for the case λ=390 W/mK and HTC=0.16 W/mm²K.

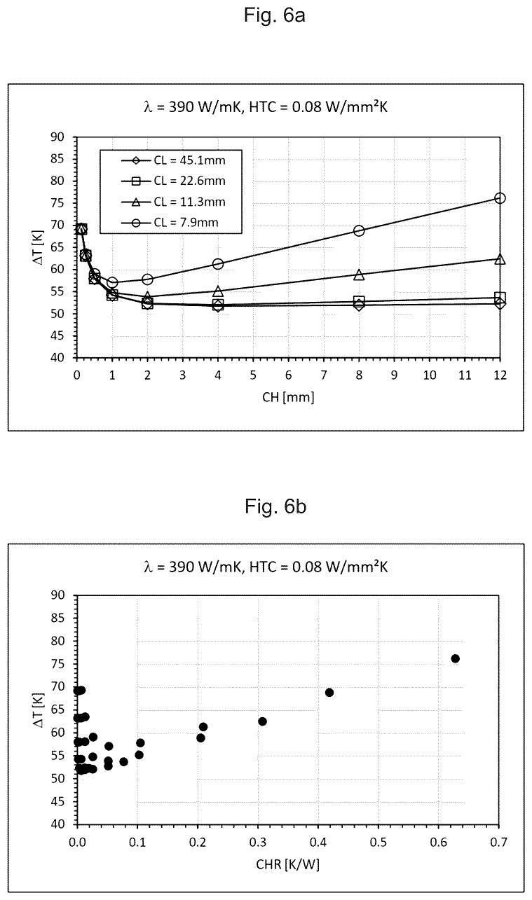

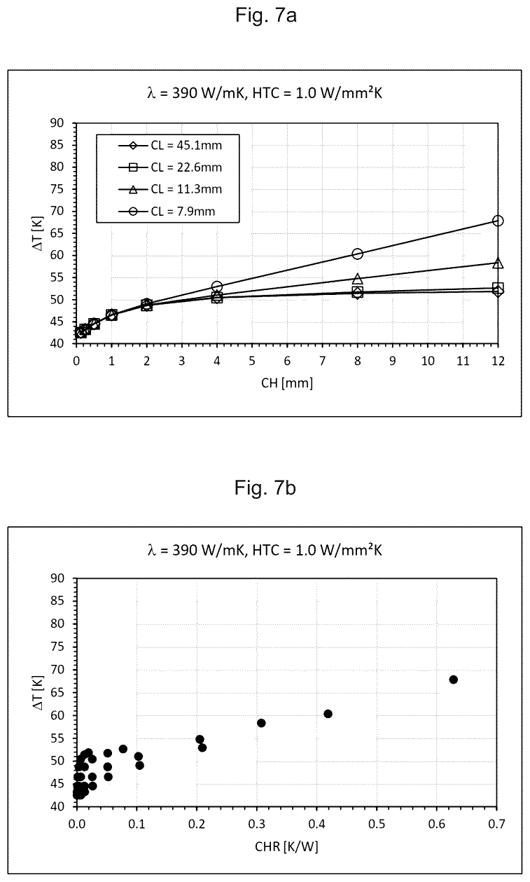

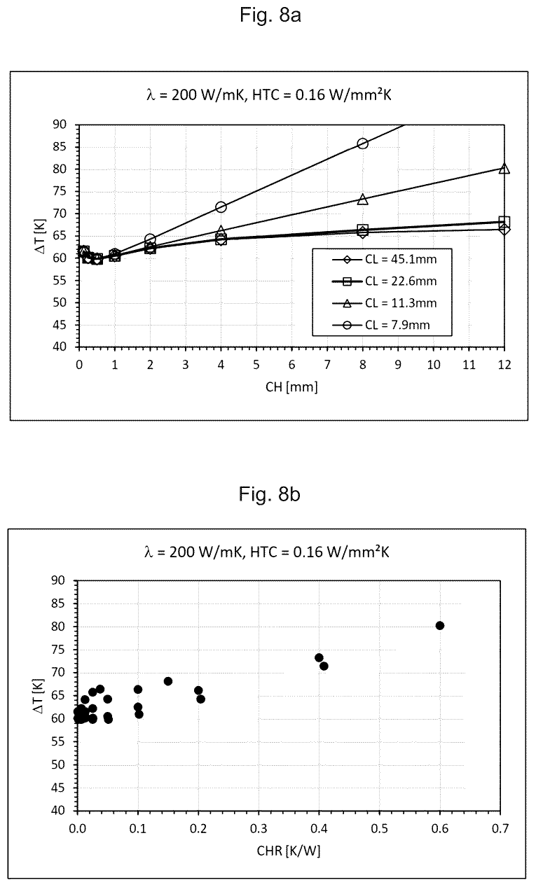

FIGS. 6-8 likewise show such results, but for other values of λ and HTC: FIG. 6a shows the temperature increase at the monitor point ΔT as a function of the characteristic height CH of the heat spreader for various characteristic lengths CL of the heat spreader, for the case λ=390 W/mK and HTC=0.08 W/mm²K. FIG. 6b shows the temperature increase at the monitor point ΔT as a function of the characteristic thermal resistance CHR, for the case λ=390 W/mK and HTC=0.08 W/mm²K. FIG. 7a shows the temperature increase at the monitor point ΔT as a function of the characteristic height CH of the heat spreader for various characteristic lengths CL of the heat spreader, for the case λ=390 W/mK and HTC=1 W/mm²K. FIG. 7b shows the temperature increase at the monitor point ΔT as a function of the characteristic thermal resistance CHR, for the case λ=390 W/mK and HTC=1 W/mm²K. FIG. 8a shows the temperature increase at the monitor point ΔT as a function of the characteristic height CH of the heat spreader for various characteristic lengths CL of the heat spreader, for the case λ=200 W/mK and HTC=0.16 W/mm²K. FIG. 8b shows the temperature increase at the monitor point ΔT as a function of the characteristic thermal resistance CHR, for the case λ=200 W/mK and HTC=0.16 W/mm²K.

In principle, a small temperature increase ΔT is advantageous. Furthermore, it is advantageous if the heat spreader can be kept as small as possible, i.e. in particular CL and CH are as small as possible.

The results shown above show the trend that a laterally larger heat spreader (CL large) leads to a smaller temperature increase. The same applies to a shallower heat spreader (CH small), and also to the case of a higher thermal conductivity (\ large), and also a better heat transfer to the heat exchanger (HTC large).

Surprisingly, however, that only applies in the case of laterally large heat spreaders (CL large). FIG. 5a shows that, in the abovementioned example, the smallest temperature increase is present for CH close to 1.0 mm, almost independently of the lateral dimension CL. Even thinner heat spreaders lead to a larger temperature increase again.

The situation is similar in FIG. 6a (HTC lower). In the case of FIG. 7a (HTC very high), the temperature increase for CH close to 1 mm and smaller is indeed also independent of CL, but ΔT continues to decrease and does not increase with lower CH. In contrast, FIG. 8a (compared to FIG. 5a, the thermal conductivity of the heat spreader is reduced here) shows similar behaviour again, but here the minimum is approximately at CH=0.5 mm.

The dependence of the temperature increase ΔT on CHR (FIG. 5b) shows similar characteristics. As CHR decreases, ΔT also decreases, but increases again starting from a value of CHR of approx. 0.04.

A further surprising result is that, in the example, an increase in CL beyond approx. 22.4 mm does not mean a further significant reduction in ΔT.

What is especially surprising is that the minimum of ΔT close to a value of CH of approx. 1 mm is particularly pronounced, the smaller CL is.

Conversely, that means that the height CH becomes less relevant starting from a certain lateral size (CL large, CA large).

A synergy of optimized heat dissipation and specific dimensions of the carrier substrate can thus be achieved in an advantageous manner with the invention. The following may be mentioned as examples:

For CL<9 mm: 0.2 mm<CH<4 mm, preferably 0.5 mm<CH<2 mm, particularly preferably 0.8 mm<CH<1.2 mm, and/or 0.010 K/W<CHR<0.21 K/W, preferably 0.026 K/W<CHR<0.10 K/W, particularly preferably 0.042 K/W<CHR<0.06 K/W.

For 9 mm<CL<13 mm: 0.2 mm<CH<9 mm, preferably 0.5 mm<CH<5 mm, particularly preferably 0.8 mm<CH<2 mm, and/or 0.005 K/W<CHR<0.23 K/W, preferably 0.013 K/W<CHR<0.13 K/W, particularly preferably 0.021 K/W<CHR<0.05 K/W.

For 13 mm<CL<23 mm: 0.2 mm<CH, preferably 0.5 mm<CH<12 mm, particularly preferably 0.8 mm<CH<4 mm, and/or 0.001 K/W<CHR, preferably 0.003 K/W<CHR<0.08 K/W, particularly preferably 0.005 K/W<CHR<0.03 K/W.

Dimensions in the optimum range allow the highest possible removal of heat generated during light conversion and thus the highest possible luminous efficiency or the highest possible input of optical power, expressed by the highest possible “irradiance limit” in conjunction with the smallest possible heat spreader.

The present invention thus makes it possible in particular to provide an optimized light conversion component with optimized heat dissipation and thus optimized luminous efficiency with at the same time reduced space consumption and also reduced costs. These advantages and synergistic effects can additionally be achieved in particular independently of the properties of the light conversion element and/or its interfaces.

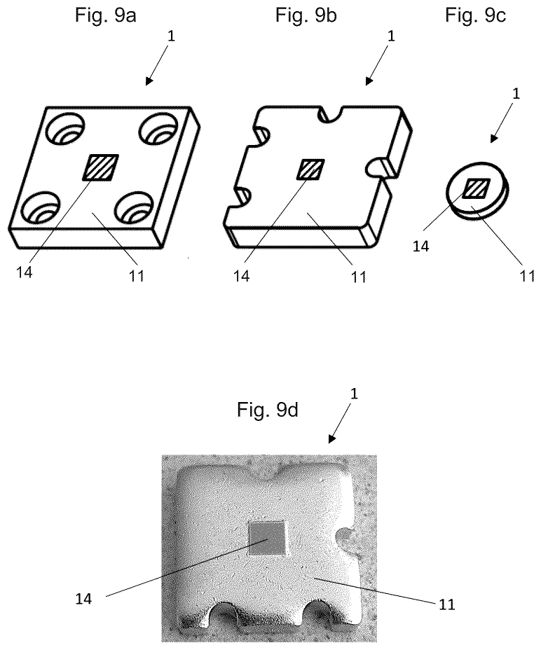

FIG. 9a shows an exemplary embodiment 1: The heat spreader consists of E-Cu with a plating of NiP and Au. The dimensions are 20 mm×20 mm×4 mm. There are 4 holes having a diameter of 2.7 mm at the underside (contact side with respect to the heat exchanger). The area A of the contact side is thus 377 mm². This results in: CL=21.9 mm, CH=4 mm, CHR=0.027 K/W.

The converter platelet consists of Ce:YAG ceramic of the format 4 mm×4 mm×0.08 mm with [Ce]=0.36 at % and a porosity of 95.5%. This comprises an AR coating, consisting of 77 nm SiO₂, on the top side. On the underside it is provided with an approx. 10 μm thick silver layer. The connection to the heat spreader was effected by means of soldering; the solder layer is approx. 30 μm thick and consists of AuSn20.

For the production of this sample, powders of the pure oxides yttrium oxide, aluminium oxide, and cerium oxide were each mixed according to the desired composition of Ce:YAG and, after addition of ethanol, dispersants and pressing aids, were admixed with grinding balls and finely ground in a barrel by means of a roller bed. The slurry was thereafter dried by means of a rotary evaporator and then uniaxially pressed into cylindrical green bodies. The green bodies were debound at approx. 600° C., followed by the reactive sintering in air at approx. 1600° C. (for several hours). The sintered bodies were sawn into wafers by means of a wire saw and then ground and polished to the desired thickness. The wafers were then printed on the rear side with a solder glass-containing Ag thick-film paste by means of screen printing. The paste was fired at approx. 900° C. On the front side, an approx. 77 nm thin AR layer of SiO₂ was vapour-deposited onto the wafers. The wafers coated on both sides in this way were singulated by means of dicing into dies of the 4×4 mm² format. For the connection to the heat spreader, a platelet composed of AuSn8020 (“preform”) was positioned in the centre of the heat spreader and the converter platelet was placed onto the solder platelet, and then the composite assembly was heated to more than 280° C. (melting point of the solder) and cooled down again.

FIG. 9b shows an exemplary embodiment 2: The heat spreader consists of E-Cu with a plating of NiP and Au. The dimensions are 20 mm×20 mm×4 mm. There are 4 grooves having width 3 mm, depth 2.5 mm, and radius 1.5 mm. The corners have a radius of 1 mm. The area A of the contact side is thus 373 mm². This results in: CL=21.8 mm, CH=4 mm, CHR=0.027.

The converter platelet consists of Ce:YAG ceramic of the format 3 mm×3 mm×0.08 mm with [Ce]=0.12 at % and a porosity of 95.5%. This comprises an AR coating, consisting of 97 nm SiO₂, on the top side. On the underside it is provided with an approx. 10 μm thick silver layer. The connection to the heat spreader was effected by means of silver sintering; the silver sintering layer is approx. 25 μm thick.

For the production of this sample, powders of the pure oxides yttrium oxide, aluminium oxide, and cerium oxide were each mixed according to the desired composition of Ce:YAG and, after addition of ethanol, dispersants and pressing aids, were admixed with grinding balls and finely ground in a barrel by means of a roller bed. The slurry was thereafter dried by means of a rotary evaporator and then uniaxially pressed into cylindrical green bodies. The green bodies were debound at approx. 600° C., followed by the reactive sintering in air at approx. 1600° C. (for several hours). The sintered bodies were sawn into wafers by means of a wire saw and then ground and polished to the desired thickness. The wafers were then printed on the rear side with a solder glass-containing Ag thick-film paste by means of screen printing. The paste was fired at approx. 900° C. On the front side, an approx. 97 nm thin AR layer of SiO₂ was vapour-deposited onto the wafers. The wafers coated on both sides in this way were singulated by means of dicing into dies of the 3×3 mm² format. For the connection to the heat spreader, an Ag sintering paste was applied at the centre of the heat spreader by means of a dispenser and the converter platelet was pressed on there, and then this connection was sintered at approx. 200° C. for approx. 2 h in air.

FIG. 9c shows an exemplary embodiment 3: The heat spreader consists of OF-Cu with a plating of Ni and Au. The dimensions are Ø8 mm×1 mm. The heat spreader is stamped out, i.e. the top side is not planar towards the edge, exhibits an indentation. The area A of the contact side is 50.3 mm². This results in: CL=8 mm, CH=1 mm, CHR=0.052.

The converter platelet consists of Ce:LuAG ceramic of the format 3 mm×3 mm×0.08 mm with [Ce]=0.5 at& and a porosity of 95.5%. This comprises an AR coating, consisting of 77 nm SiO2, on the top side. On the underside it is provided with an approx. 10 μm thick silver layer. The connection to the heat spreader was effected by means of soldering; the solder layer is approx. 30 μm thick and consists of AuSn20.

For the production of this sample, powders of the pure oxides lutetium oxide, aluminium oxide, and cerium oxide were each mixed according to the desired composition of Ce:YAG and, after addition of ethanol, dispersants and pressing aids, were admixed with grinding balls and finely ground in a barrel by means of a roller bed. The slurry was thereafter dried by means of a rotary evaporator and then uniaxially pressed into cylindrical green bodies. The green bodies were debound at approx. 600° C., followed by the reactive sintering in air at approx. 1600° C. (for several hours). The sintered bodies were sawn into wafers by means of a wire saw and then ground and polished to the desired thickness. The wafers were then printed on the rear side with a solder glass-containing Ag thick-film paste by means of screen printing. The paste was fired at approx. 900° C. On the front side, an approx. 77 nm thin AR layer of SiO₂ was vapour-deposited onto the wafers. The wafers coated on both sides in this way were singulated by means of dicing into dies of the 4×4 mm² format. For the connection to the heat spreader, a platelet composed of AuSn8020 (“preform”) was positioned in the centre of the heat spreader and the converter platelet was placed onto the solder platelet, and then the composite assembly was heated to more than 280° C. (melting point of the solder) and cooled down again.

FIG. 9d shows an exemplary embodiment 4: The heat spreader consists of E-Cu with a plating of NiP and Au. The dimensions are 20 mm×20 mm×4 mm. There are 4 grooves having width 3 mm, depth 2.5 mm, and radius 1.5 mm. The corners have a radius of 1 mm. The area A of the contact side is thus 373 mm². This results in: CL=21.8 mm, CH=4 mm, CHR=0.027.

In contrast to Example 2, this heat spreader is produced by stamping from a metal sheet. Stamping can simplify production, especially for large quantities, and machining by drilling and milling in particular can be avoided. A stamped heat spreader preferably has no steps located between the top side and the underside, i.e. horizontal areas resulting from steps and at a different level from the top side or underside, as e.g. in FIG. 9a, 2b or 2c.

Designs that can be produced particularly well are those in which the top side and underside each have only a circumferential boundary, i.e. in particular no inner perforations. The bounding edges of the top side and underside of a heat spreader stamped in this way generally differ in the edge radius, wherein e.g. the radius of one edge is less than 1 mm while the radius of the other edge is larger. The stamping of carrier substrates is suitable especially for dimensions with a characteristic length CL of the carrier substrate of between 1 mm and 23 mm, since these carrier substrates are neither too small nor too large for a stamping method. In particular, in the context of a stamping method, preferably through holes, optionally also recesses, are dispensed with and/or preferably carrier substrates with uniform thickness and/or with an edge indentation are produced, which is advantageous at the same time with regard to the heat dissipation in comparison with other forms.

What is claimed is:

1. A light conversion component for mounting on a heat exchanger, the light conversion component comprising:
a light converter having a front side and a rear side, wherein the light converter is configured to be irradiated with primary light on the front side and to emit secondary light with a wavelength changed relative to the primary light on the front side;
a thermally conductive carrier substrate carrying the light converter, wherein the carrier substrate has a carrier front side facing the rear side of the light converter and has a carrier rear side configured for bearing on the heat exchanger; and
a thermally conductive connector arranged between the light converter and the carrier substrate and establishing a mechanically fixed connection.

2. The light conversion component as recited in claim 1 wherein the carrier substrate defines a characteristic area CA, which is given as the surface area of the carrier rear side when the carrier substrate is mounted on the heat exchanger, and
wherein the carrier substrate defines a characteristic length CL=2·(CA/π)^{0.5} given as a diameter of a circular surface having a surface area corresponding to the characteristic area CA, and
wherein the characteristic length CL of the carrier substrate is greater than 1 mm and less than 23 mm.

3. The light conversion component as recited in claim 1 wherein the carrier substrate defines a characteristic height CH, given as a thickness of the carrier substrate when the carrier substrate is mounted on the heat exchanger, and
wherein the characteristic height CH of the carrier substrate is greater than 0.2 mm and is less than 4 mm.

4. The light conversion component as recited in claim 1 wherein the carrier substrate defines a characteristic thermal resistance CHR=CH/λ/CA, given as the quotient of a characteristic height CH of the carrier substrate and the thermal conductivity λ of the carrier substrate and a characteristic area CA of the carrier substrate, and wherein
a)
the characteristic thermal resistance CHR of the carrier substrate is in a range of 0.0001 K/W to 0.07 K/W and
wherein the characteristic length CL of the carrier substrate is preferably in a range of 23 mm to 100 mm and
wherein the characteristic height CH of the carrier substrate is preferably in a range of 0.2 mm to 12 mm, or
b)
the characteristic thermal resistance CHR of the carrier substrate is in a range of 0.001 K/W to 0.2 K/W, and
wherein the characteristic length CL of the carrier substrate is in a range of 13 mm to 23 mm and
wherein the characteristic height CH of the carrier substrate is in a range of 0.2 mm to 12 mm, or
c)
the characteristic thermal resistance CHR of the carrier substrate is in a range of 0.005 K/W to 0.23 K/W, and
wherein the characteristic length CL of the carrier substrate is in a range of 9 mm to 13 mm and
wherein the characteristic height CH of the carrier substrate is in a range of 0.2 mm to 9 mm, or
d)
the characteristic thermal resistance CHR of the carrier substrate is in a range of 0.01 K/W to 10 K/W, and
wherein the characteristic length CL of the carrier substrate is in a range of 1 mm to 9 mm and
wherein the characteristic height CH of the carrier substrate is in a range of 0.2 mm to 4 mm.

5. The light conversion component as recited in claim 1 wherein the carrier substrate has a coverage area covered by the light converter, and has a free area not covered by the light converter,
wherein the free area has an area in a range of 1 mm² to 400 mm², and
wherein a ratio of the area of the coverage area to the area of the free area is in a range of 0.01 to 2.5, and
wherein the carrier substrate has a mounting region located in the free area of the carrier substrate, wherein the mounting region comprises a mount, the carrier substrate securable via the mount on the heat exchanger.

6. The light conversion component as recited in claim 1 wherein the carrier substrate is disc-shaped, plate-shaped or cylindrical, or
wherein the carrier substrate is shaped so as to be simply connected in a mathematical-topological sense, or
wherein the carrier substrate has an outwardly oriented edge connecting the carrier front side to the carrier rear side, and wherein the carrier substrate has only the outwardly oriented edge and has no inwardly oriented edge, or
wherein the carrier substrate has a uniform thickness or has a minimum thickness deviating from the maximum thickness by at most 50%.

7. The light conversion component as recited in claim 1 wherein the carrier substrate is produced by stamping, or
wherein the carrier substrate has a circumferential front side edge forming a transition from the carrier front side to an edge of the carrier substrate, and has a circumferential rear side edge forming a transition from the carrier rear side to the edge of the carrier substrate, and wherein the front side edge has an average rounding radius differing from an average rounding radius of the rear side edge, and wherein the larger of the front side edge and rear side edge average rounding radii is less than 4 mm.

8. The light conversion component as recited in claim 1 wherein the carrier substrate has a thermal conductivity greater than 100 W/mK, or
wherein the carrier substrate includes predominantly a material having a thermal conductivity λ which is greater than 100 W/mK, or
wherein the carrier substrate comprises copper, or
wherein the carrier substrate is provided with a coating.

9. The light conversion component as recited in claim 1 wherein the connector has a thermal conductivity which is greater than 10 W/mK, or
wherein the connector comprises at least one solder connection.

10. The light conversion component as recited in claim 1 wherein the connector is arranged between the light converter and the carrier substrate in such a way that the connector covers the rear side of the light converter over the whole area or a proportion thereof amounting to at least 75% or
wherein the connector has a thickness which is in the range of 1 μm to 100 μm, or
wherein the connector is arranged between the light converter and the carrier substrate in such a way that the plane defined by the carrier front side and the plane defined by the front side of the light converter run parallel or deviate by an angle of less than 10°, or
wherein the connector establishes a mechanically fixed connection between the carrier substrate,
wherein the adhesive strength of the light converter on the carrier substrate is greater than 1 MPa.

11. The light conversion component as recited in claim 1
wherein the light converter has a thickness which is in a range of 50 μm to 250 μm, or
wherein the light converter has dimensions transversely with respect to the thickness in the range of 0.5 mm×0.5 mm to 20 mm×20 mm.

12. The light conversion component as recited in claim 1 wherein the light converter has a thermal conductivity which is greater than 1 W/mK, or
wherein the light converter comprises a material A₃B₅O₁₂, with A selected from the group of lanthanides and Ce, B selected from Al and Ga, or
wherein the material of the light converter includes a ceramic.

13. The light conversion component recited claim 1 wherein the light converter has a rear side coating on the rear side,
wherein the rear side coating is a reflective coating, or
wherein the rear side coating is produced by printing a thick film paste and subsequent firing or via vapor deposition or sputtering, or
wherein the rear side coating comprises, deposited on the light converter, an optically transparent layer of material having a refractive index lower than that of the material of the light converter, or
wherein the rear side coating has a thickness of at least 250 μm, or
wherein the rear side coating comprises at least one optically transparent layer deposited on the converter and at least one further metallic layer deposited thereon, or
wherein the light converter has on the front side a front side coating formed as an anti-reflection coating.

14. A light conversion assembly comprising:
the light conversion component as recited in claim 1,
the heat exchanger, the light conversion component being mounted on the heat exchanger.

15. The light conversion assembly as recited in claim 14
wherein the heat exchanger comprises a connection configured to secure the light conversion component on the heat exchanger,
wherein the connection of the heat exchanger interacts with a mount of the light conversion component.

16. The light conversion assembly as recited in claim 15 wherein the heat exchanger has a thermal conductivity greater than 50 W/mK, or
wherein the heat conducting medium is introduced between the carrier substrate of the light conversion component and the heat exchanger in such a way that the heat conducting medium covers the rear side of the light converter over at least a proportion thereof amounting to at least 75%, or
wherein the heat conducting medium is formed as a heat conducting paste, heat conducting gel, heat conducting pad or heat conducting adhesive.

17. The light conversion assembly as recited in claim 16 wherein the heat exchanger comprises at least one of the following materials: aluminium, aluminium alloy, copper, brass, copper alloy, steel, or silicon, or
wherein the heat exchanger comprises cooling fins or heat pipes or
wherein a fan or pipes for the flow of cooling liquid or a Peltier cooler are mounted at or on the heat exchanger.

18. A lighting device comprising:
the light conversion component as recited in claim 1, and
a light source for irradiating the front side of the light converter of the light conversion component with primary light.

19. The lighting device as recited in claim 18 wherein the primary light generates on the front side of the light converter a luminous spot having a size in the range of 0.05 mm² to 20 mm², or
wherein a ratio of the size of the luminous spot to the front side of the light converter is in the range of 0.003 to 0.63, or
wherein the carrier substrate has a higher thermal conductivity than the heat exchanger.

20. A method for producing a light conversion component comprising the following steps:
providing a carrier substrate,
providing a light converter and applying the light converter on the carrier substrate,
wherein a connector is arranged between the light converter and the carrier substrate, the connector establishing a mechanically fixed connection.
